(19) United States
(12) Patent Application Publication
(10) Pub. No.: US 2010/0320767 A1
(43) Pub. Date: Dec. 23, 2010

(54) PRESSURE GRID SYSTEM AND METHOD OF USING

(76) Inventor: Elvin Lloyd Knollman, Greensburg, IN (US)

Correspondence Address: HARTMAN & HARTMAN, P.C., 552 EAST 700 NORTH, VALPARAISO, IN, 46383, US

(21) Appl. No.: 12/818,348

(22) Filed: Jun. 18, 2010

Related U.S. Application Data
(60) Provisional application No. 61/269,072, filed on Jun. 20, 2009.

(51) Int. Cl. B65G 5/00; F03G 7/00; F03B 13/00

(52) U.S. Cl. 290/54; 60/325; 60/641.2; 405/53

(57) ABSTRACT

A pressure grid system and method suitable for obtaining and/or generating, storing, distributing and using a pressurized gas. The pressure grid system obtains and/or generates pressurized gas by using the energy from various sources, preferably natural resources such as wind power, hydro power, etc. At least a portion of the pressurized gas is stored in one or more subterranean locations, from which the pressurized gas can be transported to end users for their use, for example, by converting the energy of the pressurized gas to another form of energy, such as electrical, mechanical, and/or thermal.

### CROSS REFERENCE TO RELATED APPLICATIONS

This application claims the benefit of U.S. Provisional Application No. 61/269,072, filed Jun. 20, 2009, the contents of which are incorporated herein by reference.

### BACKGROUND OF THE INVENTION

The present invention generally relates to energy production and usage, and more particularly to the generation, storage, distribution and usage of a pressurized gas as an energy source and medium.

In view of environmental concerns relating to power generation using fossil fuels, there is a tremendous interest in obtaining energy from what are currently known as “green” sources, such as wind, thermal, hydro and other power sources. Conventional practice is to use these energy sources to generate electrical energy (electricity), which is then transmitted via an electric grid to various locations where the electricity is used by converting the electrical energy to another energy form, such as mechanical (for example, machines), electromagnetic (for example, electromagnetic radiation for lighting) thermal (for example, heating), etc. While advances have been made, it can be appreciated that further advancements would be desirable, particularly if such advancements could be obtained with minimal environmental impact.

### BRIEF DESCRIPTION OF THE INVENTION

The present invention provides a pressure grid system and method suitable for obtaining and/or generating, storing, distributing and using a pressurized gas as an energy source or medium.

According to a first aspect of the invention, the pressure grid system includes means for obtaining and/or generating the pressurized gas, means for storing the pressurized gas in a subterranean location, means for transporting the pressurized gas from the obtaining/generating means to the storing means, and means for utilizing the pressurized gas by converting energy of the pressurized gas to another form of energy.

According to a second aspect of the invention, the method uses the pressure grid system described above to obtain and/or generate, store, distribute and use a pressurized gas. The method includes obtaining and/or generating the pressurized gas, transporting the pressurized gas to the storing means, storing at least a portion of the pressurized gas in the subterranean location, and utilizing the pressurized gas by converting energy of the pressurized gas to another form of energy.

A significant technical effect of this invention is the ability to obtain and/or generate a pressurized gas, for example, air, using “green” natural energy resources such as wind and hydro power, store the pressurized air in subterranean locations with minimal impact on the surrounding environment, and then use the pressurized air directly as a pneumatic energy source or by converting the stored energy of the pressurized gas to another energy form, such as electrical, mechanical, thermal, aerodynamic, etc. Each of these steps can be carried out with minimal risk of contaminating the environment with pollutants released into the atmosphere, groundwater, or bodies of water.

Other aspects and advantages of this invention will be better appreciated from the following detailed description.

### BRIEF DESCRIPTION OF THE DRAWINGS

FIG. 1 is a schematic representing a pressure grid system adapted to obtain and/or generate, store and distribute pressurized air for use as an energy source in residential, commercial, industrial, utility, power generation and other facilities and applications.

### DETAILED DESCRIPTION OF THE INVENTION

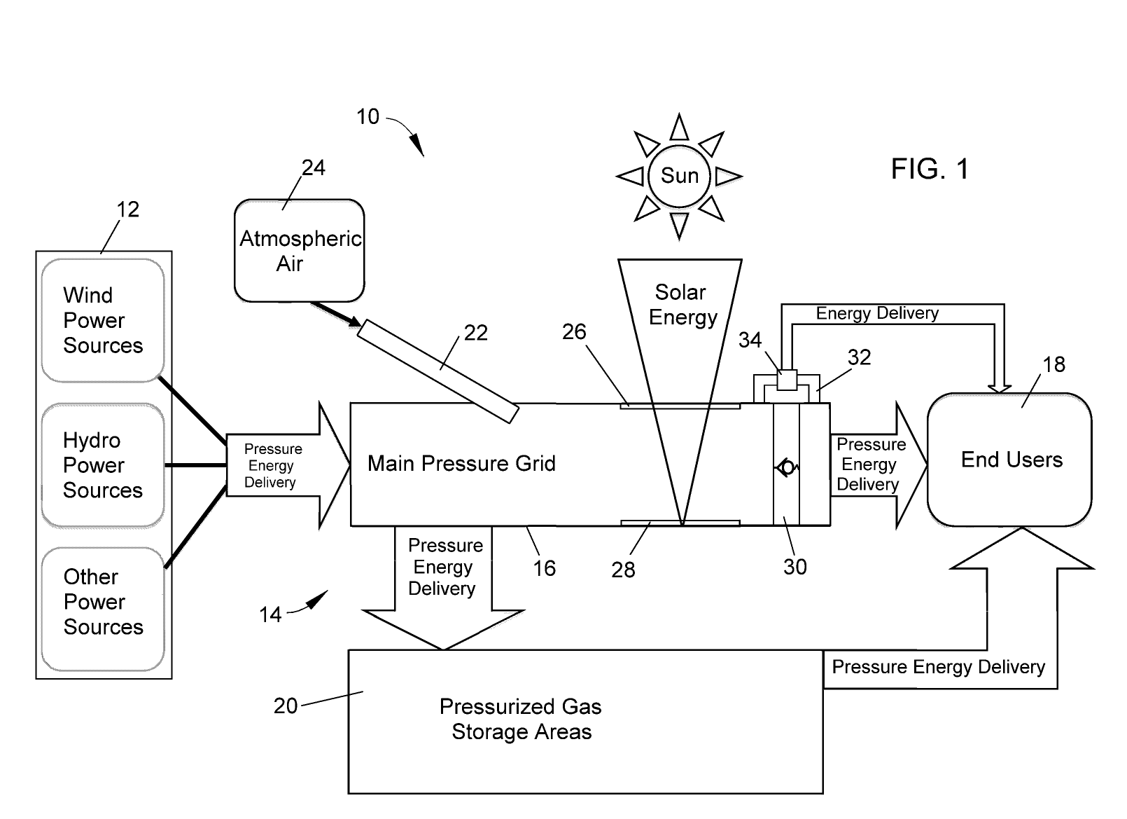

FIG. 1 schematically represents what is referred to herein as a pressure grid system 10. In its preferred embodiment, the system 10 is a green energy concept that utilizes natural resources to generate a pressurized (compressed) gas, preferably air, for delivery to an end user. The system 10 and methods employing the system 10 include the generation or otherwise obtaining of a pressurized gas, and then the transportation, storage, and usage of the pressurized gas.

For convenience, the invention will be described as using atmospheric air as the gas, though it should be understood that other gases could be used. Using air as a reference, pressurized or compressed air will refer to air that is above atmospheric pressure, with increasing pressures corresponding to more stored energy that can be advantageously utilized. In preferred embodiments, pressures exceeding 2 bar will be typical, with pressures of about 2000 psi (about 140 bar) or more being possible and potentially more desirable.

Various sources are available for obtaining and/or generating pressurized air. Three nonlimiting examples of suitable sources 12 are collectively identified in FIG. 1: wind power, hydro power, and others such as electrical power. Wind turbines are currently used on both small and large scales (for example, wind farms) to produce electrical energy. According to the invention, a wind turbine can instead be coupled to a compressor that compresses atmospheric air. Hydro power sources include, but are not limited to, water flowing in rivers and streams, as well as currents within large bodies of water such as oceans. In the case of river currents, an apparatus floating on or suspended above the surface of a river can be equipped with paddle wheels mounted on a shaft and adapted to cause the shaft to rotate. The shaft can be coupled to a compressor that compresses atmospheric air. In addition, an apparatus can be submerged beneath the surface of a river to draw power from currents. For example, a submerged water turbine can be used to turn a shaft coupled to a compressor that compresses atmospheric air. Another potential source of energy that can be extracted from subsurface currents is referred to as vortex hydro energy. As disclosed in U.S. Pat. No. 7,493,759, whose contents are incorporated herein by reference, a converter (“VIVACE converter) uses the phenomenon of vortex induced vibrations (VIV) to convert hydrokinetic energy of underwater currents to electricity, which in turn can be used to operate a compressor to compress atmospheric air. Yet another example is a dam in a river, which in conventional practice conducts water through a water turbine to drive a generator and produce electricity. According to the invention, such a turbine can instead be coupled to a compressor that compresses atmospheric air. Finally, it may be advantageous to power a compressor with electricity during periods of off-peak demand. The use of various other equipment for powering a compressor, both existing and developed in the future, are also within the scope of the invention. In addition, various types of equipment exist and could be developed that are capable of compressing air (or another suitable gas), including such nonlimiting examples as screw and piston-type compressors. The construction, operation, and use of wind turbines, paddle wheels, water turbines, vortex devices, compressors, etc., are all well within the knowledge and capability of those skilled in the art, and therefore will not be discussed in any detail here.

The pressurized air generated or obtained as described above can then be delivered by pipeline to a main pressure grid 14, represented in FIG. 1 as a single pipeline 16 but for practical reasons will preferably comprise a large network of any number of fluidically connected pipelines. Suitable pipeline materials include those existing and used to convey and distribute gases, such as natural gas pipelines commonly found in the utility industry. The pressure grid 14 would preferably define an extensive network capable of collecting pressurized air from the various possible sources 12 (wind farms, rivers, etc.) and delivering the pressurized air to end users 18, which may include residential, commercial, industrial, utility, power generation and other facilities. Suitable sizes for individual pipes and pipelines of the grid 14 will be determined in part by their proximity to the sources 12 and the end users 18, any storage capacity desired by the pipelines, as well as other factors. Check valves (not shown) may be placed periodically along the pipeline grid 14 and at inlets from the sources 12 to prevent backflow that would cause pressure loss in the grid 14.

In a preferred embodiment, the bulk of the compressed air is delivered to pressurized gas storage areas 20, preferably subterranean locations including natural caverns (such as limestone caverns, salt caverns and abandoned coal mines), manmade caverns, and/or other manmade storage facilities. Various natural caverns capable of containing extremely large volumes of pressurized air are known and located in various geographical locations around the world, an example of which are limestone caverns located in Indiana, USA. The suitability of a given cavern can be determined through appropriate geological studies.

FIG. 1 further depicts additional air as being drawn into the main pressure grid 14 with a venturi 22. If compressed air moves through the pipeline 16 of the grid 14 at sufficient velocities, atmospheric air 24 may be pulled into the venturi 22 to contribute to the air mass within the pipeline 16. A check valve (not shown) can be employed to prevent backflow of air to atmosphere. In addition to or as an alternative to placement in a pipeline 16, venturi may be placed at the entrances to the pressurized gas storage areas 20.

FIG. 1 also depicts the energy of the pressurized air within the main pressure grid 14 as being increased through the use of thermal energy, represented in FIG. 1 as being obtained from solar energy. As represented, solar radiation passes through an upper wall 26 of the pipeline 16 and impinges a lower wall 28 of the pipeline 16. For example, the upper wall 26 may be formed of a material that is transparent or at least translucent to solar radiation, while the lower wall 28 may be formed of a material that absorbs solar radiation. As a result, solar energy heats the lower wall 28, which transfers heat to the air adjacent the lower wall 28. The heating of the air within the pipeline 16 increases its energy content, and may be sufficient to cause the air to expand and thereby increase the air pressure in the pipeline 16 and storage area(s) 20 downstream of the pipeline 16. Alternatively or in addition, solar energy can be collected with solar panels (not shown) or other solar energy collection devices placed along pipelines of the main pressure grid 14, preferably near entrances to pressurized gas storage areas 20. Other sources of thermal energy are also contemplated, including conventional geothermal heating techniques that extract heat stored in the Earth.

Pressurized air within the main pressure grid 14 (including any of its individual pipelines 16) and within the storage areas 20 can then be drawn for use by end users 18. End use can be in the form of direct use of the pressurized air, for example, to supply a compressed air system within an industrial facility. In addition to various other uses, the energy stored in the pressurized air can be converted to mechanical energy, for example, by powering pneumatic tools and other machinery operated by compressed air. The energy stored in the pressurized air can also be converted to other energy forms, such as electrical energy, thermal energy, or aerodynamic forms of energy. For example, the pressurized air can be delivered to an electrical power generation station that converts the energy of the pressurized gas to electrical energy, for example, through the use of an air turbine or pneumatic motor that drives an electric generator. The generated electricity can then be placed on the electrical grid or directly linked to businesses, homes, utilities, etc., within the local community.

Pressurized air can also be delivered to a thermal power generation station that converts the energy of the pressurized gas to thermal energy. Advantageously, pressurized air drawn from the subterranean storage areas 20 will be at a temperature approximately equal to the surrounding ground temperature. This air can be drawn from the storage areas 20 and passed through heat exchangers to heat or cool buildings, or passed through vortex tubes to generate separate streams of relatively hot and cool air for use in heating, cooling, air conditioning, cold storage, etc.

Other emerging technologies can also make use of the pressurized air off the pressure grid 14, including vortex apparatuses such as vortex tubes, which convert the energy stored in the pressurized gas to another energy form by generating an air vortex. Any of these end users 18 can be placed virtually anywhere along a pipeline of the pressure grid 14 or near a storage area 20 on the pressure grid 14.

It is also within the scope of the invention to step-down the pressure within the pressure grid 14 at locations anywhere along the length of a pipeline of the grid 14, and deliver energy extracted from the pressure step-down to end users 18. As an example, FIG. 1 shows a check valve 30 placed in the pipeline 16. The valve 30 is spring-loaded, wherein the valve 30 opens if pressure upstream of the valve 30 is greater than downstream of the valve 30 by a pressure differential established by a spring or other biasing means. For example, the valve 30 could be set to operate on a 100 psi (about 7 bar) differential, so that the pressure downstream of the valve 30 is maintained at a level of about 100 psi less than upstream of the valve 30. Pressure drawn from the pipeline 16 upstream of the valve 30 is then routed through a bypass pipe 32 to operate a motor, turbine, or any other suitable device 34 capable of utilizing airflow to generate energy, for example, a motor or turbine that drives a generator to produce electrical energy delivered to end users 18. In addition to providing locations for drawing off pressure energy, the step-down feature also provides a technique for regulating pressure within the grid 14.

While the invention has been described in terms of specific embodiments, it is apparent that other forms could be adopted by one skilled in the art. For example, the physical configuration of the pressure grid system and its components could vary considerably, and various equipment and processes other than those noted could be used. Therefore, the scope of the invention is to be limited only by the following claims.

1. A pressure grid system for obtaining and/or generating, storing, distributing and using a pressurized gas, the system comprising:
means for obtaining and/or generating the pressurized gas;
means for storing the pressurized gas in a subterranean location;
means for transporting the pressurized gas from the obtaining/generating means to the storing means; and
means for utilizing the pressurized gas by converting energy of the pressurized gas to produce another form of energy.

2. The pressure grid system according to claim 1, wherein the obtaining/generating means is chosen from the group consisting of compressors driven by wind power, compressors driven by hydro power, and compressors driven by electrical power.

3. The pressure grid system according to claim 1, wherein the obtaining/generating means comprises a compressor driven by wind power.

4. The pressure grid system according to claim 3, wherein the compressor is driven by a wind turbine.

5. The pressure grid system according to claim 1, wherein the obtaining/generating means comprises a compressor driven by hydro power.

6. The pressure grid system according to claim 5, wherein the compressor is driven by water flowing in a river.

7. The pressure grid system according to claim 1, wherein the obtaining/generating means comprises means for generating the pressurized gas using a venturi effect.

8. The pressure grid system according to claim 1, further comprising means for increasing the energy pressure of the pressurized gas within the transporting means using thermal energy.

9. The pressure grid system according to claim 8, wherein the increasing means comprises means for collecting solar radiation to produce the thermal energy.

10. The pressure grid system according to claim 1, wherein the storing means is at least one subterranean location chosen from the group consisting of natural caverns and manmade caverns.

11. The pressure grid system according to claim 1, wherein the storing means is at least one subterranean location chosen from the group consisting of limestone and salt caverns.

12. The pressure grid system according to claim 1, wherein the transporting means comprises a plurality of fluidically connected pipelines.

13. The pressure grid system according to claim 12, wherein the obtaining/generating means comprises a venturi adapted to utilize flow of the pressurized gas through at least a first pipeline of the fluidically connected pipelines to draw air from the atmosphere into the first pipeline.

14. The pressure grid system according to claim 12, further comprising means for increasing the energy of the pressurized gas within at least a first pipeline of the fluidically connected pipelines.

15. The pressure grid system according to claim 14, wherein the increasing means comprises means for collecting solar radiation to produce the thermal energy and transferring the thermal energy to the first pipeline.

16. The pressure grid system according to claim 1, wherein utilizing means is chosen from the group consisting of an electrical power generation station that converts the energy of the pressurized gas to electrical energy, a pneumatic machine that converts the energy of the pressurized gas to mechanical energy, a geothermal power generation station that converts the energy of the pressurized gas to thermal energy, and a vortex apparatus that converts the energy of the pressurized gas to an aerodynamic energy form by generating a vortex with the gas.

17. A method of using the pressure grid system according to claim 1 to obtain and/or generate, store, distribute and use the pressurized gas, the method comprising:
obtaining and/or generating the pressurized gas with the obtaining/generating means;
transporting at least a portion of the pressurized gas from the obtaining/generating means to the storing means using the transporting means;
storing the portion of the pressurized gas in the subterranean location; and
utilizing the pressurized gas by converting energy of the pressurized gas to another form of energy.

18. The method according to claim 17, wherein the pressurized gas is obtained and/or generated with compressors driven by at least one of wind power, hydro power, and electrical power.

19. The method according to claim 17, wherein the portion of the pressurized gas is stored in at least one natural or manmade cavern.

20. The method according to claim 17, wherein the pressurized gas is utilized by at least one of an electrical power generation station that converts the energy of the pressurized gas to electrical energy, a pneumatic machine that converts the energy of the pressurized gas to mechanical energy, a geothermal power generation station that converts the energy of the pressurized gas to thermal energy, and a vortex apparatus that converts the energy of the pressurized gas to an aerodynamic energy form by generating a vortex with the gas.
